(19) United States
(12) Patent Application Publication
(10) Pub. No.: US 2010/0034949 A1
(43) Pub. Date: Feb. 11, 2010

(54) Method and system for flash freezing coffee-flavored liquid and making warm coffee-based beverages

(76) Inventors: Curt Jones, (US); Robert Lynn, (US)

Correspondence Address: STOCKWELL & SMEDLEY, PSC, 861 CORPORATE DRIVE, SUITE 200, LEXINGTON, KY, 40503, US

(21) Appl. No.: 12/462,893

(22) Filed: Aug. 11, 2009

Related U.S. Application Data
(60) Provisional application No. 61/188,595, filed on Aug. 11, 2008.

(51) Int. Cl. F25C 1/22; A23F 5/00; A23F 5/30; A23F 5/14; A23F 5/40; A47J 31/00

(52) U.S. Cl. 426/594; 99/279; 426/520; 426/519; 62/340; 62/74

(57) ABSTRACT

An apparatus and method of flash freezing a coffee-based liquid into small beads and then packaging the beads for consumers is disclosed. The beads are stored in a conventional freezer until desired and then reconstituted into a coffee beverage base as needed. In particular, a warm coffee-based beverage may be easily and affordably created using the frozen beads.

### RELATED APPLICATIONS

The present application claims priority to provisional Patent Application Ser. No. 61/188,595 filed Aug. 11, 2008, the disclosure of which is incorporated by reference herein, in its entirety.

### FIELD OF THE INVENTION

The present invention relates to beverages and more particularly to an apparatus and method for creating a flash frozen coffee beverage.

### BACKGROUND OF THE INVENTION

Various coffee-based drinks are available such as cappuccino, espresso, flavored-coffees, and regular coffee. Some drinks are served chilled, some hot, and some with extra ingredients and toppings as well. Regardless of the way most coffee-based drinks are served, they typically start out as coffee beans that are brewed, steamed, roasted, or processed at the location where the drink is being served.

Keeping coffee beans fresh is important to maintaining the flavor and aroma of drinks made using those beans. There are many techniques that have previously been used to try to maintain the freshness of coffee beans. While vacuum packing and other packaging are known techniques, it is also well known that freezing coffee beans appears to help maintain their freshness.

However, enjoying a fresh tasting coffee drink requires either a laborious process at home using consumer-quality equipment or traveling to a coffee specialty shop where commercial-grade equipment can produce a quality drink but often at a hefty price. There remains the need, therefore, for a product and method of its manufacture and use which allows quality coffee flavored drinks to be easily and affordably produced by a typical consumer.

### SUMMARY OF THE INVENTION

Embodiments of the present invention relate to a method of flash freezing a coffee-based liquid into small beads and then packaging the beads for consumers. The beads are stored in a conventional freezer until desired and then reconstituted into a coffee beverage base as needed. In particular, a warm coffee-based beverage may be easily and affordably created using the frozen beads.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts flash freezing apparatus in accordance with the principles of the present invention.

FIG. 2 depicts exemplary beads in accordance with the principles of the present invention.

FIG. 3 depicts a flowchart of an exemplary method for making flash frozen coffee-based beads according to an embodiment of the present invention.

FIG. 4 depicts a flowchart of an exemplary method for making flash frozen coffee-based beads according to another embodiment of the present invention.

FIG. 5 depicts a flowchart of an exemplary method of making a warm coffee-based beverage in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

As a result of the methods described herein, there are provided formulations of frozen coffee-based beverages in the form of small particulate shapes that remain free-flowing during storage and which can be used alone or in combination to be reconstituted into various coffee-based beverages. The particulate shapes, generally referred to as “beads”, may have a generally spherical, spheroid shape but may also have an oblong, elliptical, oblate, tubular, or other slightly irregular shape. In addition to having an irregular overall shape, the surface of the particulate shape may also be either smooth or irregular (e.g. bumpy, pocked, etc.). On average, the particulate shapes will preferably have a diameter of about 5 mm or less but can also be larger such as between about 6 and about 10 mm. Particulate shapes having diameters outside these ranges are also contemplated. For non-spherical shapes which do not have a conventional diameter, the diameter is considered to be the diameter of the smallest sphere into which the particulate shape would fit.

It is desired that the particulate or beaded product is in a free-flowing format so that it is readily pourable or spoonable. Free-flowing, as used herein, is a broad term which includes the ability of the product to flow as individual particulate shapes, with little or no clumping or sticking to each other, during such pouring or spooning. There may be slight sticking after a period of storage, but a light tap on the container will unstick the particulate shapes and allow them to be free flowing. The generally spherical shape helps contribute to the free-flowing, pourable product.

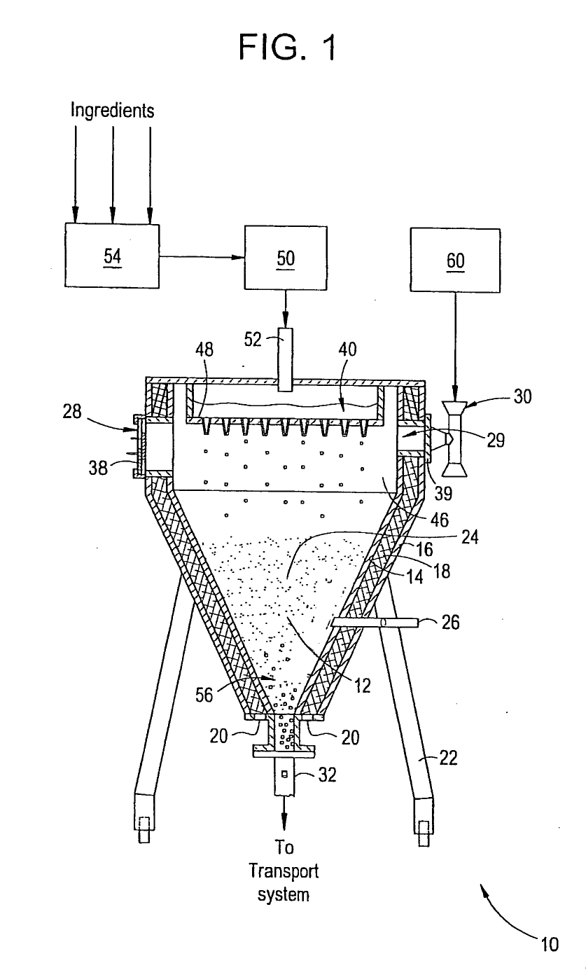

FIG. 1 shows a cryogenic processor constructed in accordance with an embodiment of the present invention to produce free-flowing beads 56.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized particles or beads 56 of frozen product, uniformly sized droplets of liquid composition are desirable that are to be fed through gas diffusion chamber 46 to freezing chamber 12. The feed tray 48 is designed with feed assembly 40 that forms droplets of the desired character. The frozen product takes the form of beads that are formed when the droplets of liquid composition contact the refrigerant vapor in the gas diffusion chamber 46, and subsequently the liquid refrigerant 24 in the freezing chamber 12. After the beads 56 are formed, they fall or are mechanically directed to the bottom of chamber 12. A transport system connects to the bottom of chamber 12 at outlet 32 to carry the beads 56 to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow desired.

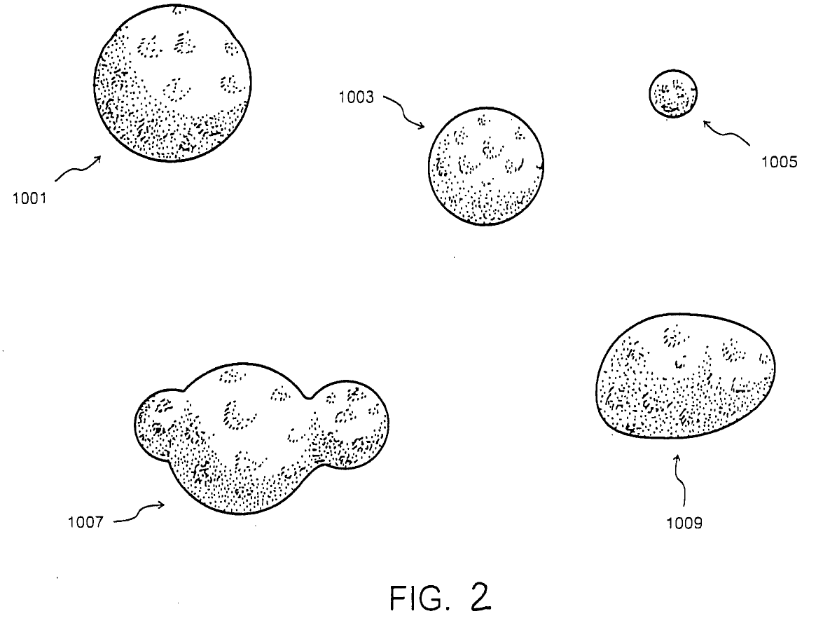

In accordance with preferred embodiments, there are provided formulations of frozen coffee flavored confections in the form of small particulate shapes. The particulate shapes may have a generally spherical, spheroid shape as shown in FIG. 2 (e.g., 1001,1003, 1005), but may also have an oblong, elliptical, oblate, tubular, or other slightly irregular shape as also shown in FIG. 2 (e.g., 1007, 1009). In addition to having an irregular overall shape, the surface of the particulate shape may also be either smooth or irregular (e.g. bumpy, pocked, etc.). On average, the particulate shapes will preferably have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. Particulate shapes having diameters outside these ranges are also contemplated. For non-spherical shapes which do not have a conventional diameter, the diameter is to be the diameter of the smallest sphere into which the particulate shape would fit.

As mentioned earlier, it is desired that the beaded product is in a free-flowing format so that it is readily pourable or spoonable. Free-flowing, as used herein, is a broad term which includes the ability of the product to flow as individual particulate shapes, with little or no clumping or sticking to each other, during such pouring or spooning. There may be slight sticking after a period of storage, but a light tap on the container will unstick the particulate shapes and allow them to be free flowing. The generally spherical shape helps contribute to the free-flowing, pourable product.

In preferred embodiments, particulate shapes that can be stored at higher temperatures, such as in a home freezer or in a grocery dairy freezer are provided, such particulate shapes being able to maintain a free-flowing form while being stored at a temperature between about −10° F. and 0° F. with an occasional rise to perhaps as much as +5° F. One way to accomplish this is to increase the freezing point (reduce the freeze-point depression) of the liquid formulation that forms the particulate shapes, although other ways may also be used.

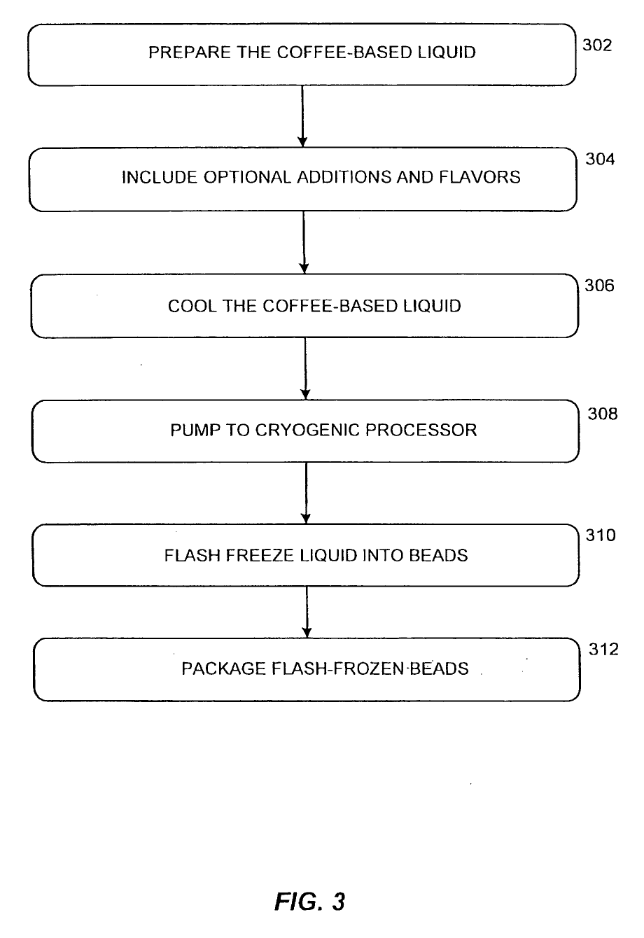

FIG. 3 depicts a flowchart of an exemplary method of making a coffee-based particulate beads in accordance with the principles of the present invention.

The first step 302 shown in FIG. 3 is that of preparing the coffee-based liquid. While the base ingredient of this liquid is coffee, there are a number of additional ingredients and flavors that may be added as well during the preparation Attorney Docket No.: 925-004 process, in accordance with other embodiments. Dairy products, flavored syrups, flavored oils, sugars, sweeteners, herbs, spices and the like may be added, for example in a raw form or pre-processed form. In preparing the coffee-based liquid, the coffee may be brewed, steamed or pressed to have a particular strength, caffeine content, or other desired characteristic. Also, flavors from various liqueurs and syrups, as well as the ingredients listed above, may be part of the formulation as well, either before or after the coffee-based liquid is prepared. The number of various formulations that may be turned into coffee-based liquids in accordance with the principles of the present invention are limited only by the creativity of the food scientist and the preferences of consumers.

As is known, coffee-based liquids may be prepared by various brewing methods as well as alternative methods as well. For example, in accordance with at least one embodiment, the coffee-based liquid is substantially traditional espresso. Espresso is prepared from dark, roasted coffee beans that are first ground to a desired size. Then water at around 195 to 200° F. is forced through the finely ground coffee at between 9-15 bars of pressure. The resulting coffee-based liquid has a highly concentrated coffee flavor.

Once the liquid is prepared, another opportunity exists, at step 304, to add additional flavors, ingredients or additives in order to formulate a variety of different coffee-based liquids. In step 306, the coffee-based liquid is optionally cooled if the liquid is prepared in such a way as to be warm. The cooling can be accomplished by a variety of different methods that are well known. Preferably the coffee-based liquid is cooled to about 40° F. in a matter of minutes or less. While as low a temperature as possible is desirable to improve the efficiency of later cryogenic processing, the temperature to which the liquid is cooled depends on the desired viscosity of the liquid as it is transported through to later stages of processing. Thus, additives may be included, such as stabilizers, that allow cooling to lower temperatures while ensuring the liquid easily flows and improve the liquids freezing characteristics. The coffee-based liquid is transported such as by being pumped, in step 308, to a frozen bead-making apparatus such as, for example, the device shown and described earlier with respect to FIG. 1. As mentioned, the consistency of the liquid may be adjusted to accommodate the pump 50 and the temperature of the liquid may be adjusted as well by well known cooling techniques that can be applied during transport to the freezing apparatus. The temperature and consistency may also adjusted to help the development of uniformly-sized beads within the freezing apparatus. Depending on the viscosity of the original fluid, different temperatures and consistencies may be used for different liquids that are dispensed into the freezing apparatus.

The next step, 310, is to freeze the coffee-based liquid into beads as described with respect to FIG. 1. In addition, utilizing alternative cryogenic freezing processes are also contemplated within the scope of the present invention. These beads can then be transported to a packaging machine. The transporting of the beads can be accomplished in a variety of different ways such as by a feed screw, a moving conveyor belt, or gravity feed. The transporting means can also be cooled such that the beads remain cool while being transported to the packager. In general, the entire process from the grinding of the coffee beans to the packaging and storing of the beads can be accomplished in a time-frame measured in minutes and is, preferably accomplished in less than 10 minutes. In this way, a flash-frozen coffee-based product is produced that can be easily reconstituted to make a fresh tasting coffee beverage. However, process times greater than or less than 10 minutes may be desirable in some embodiments and are contemplated within the scope of the present invention.

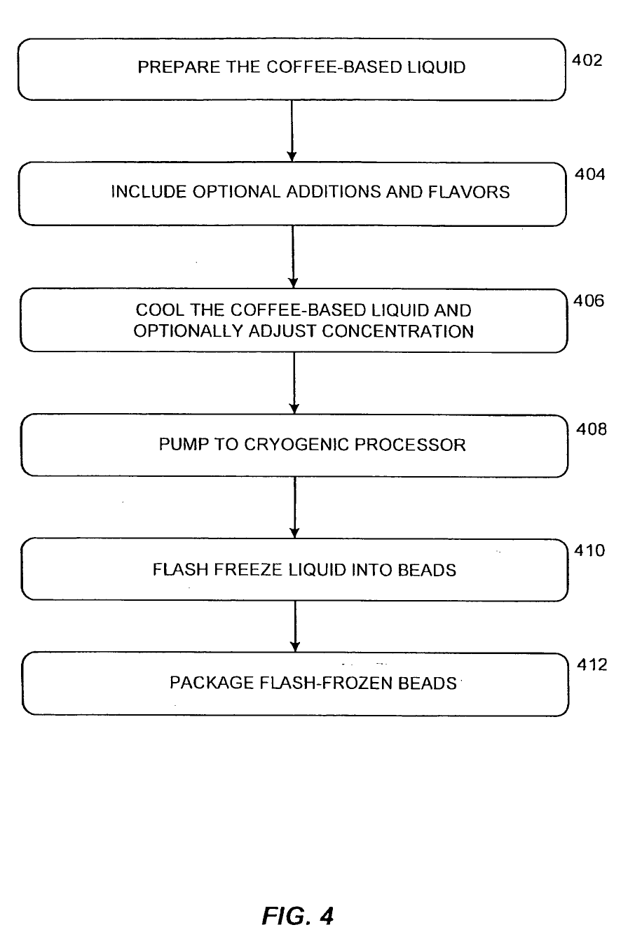

Using the example embodiment described above, the resulting coffee-based frozen particulate beads can have a relatively highly concentrated coffee flavor. Alternatively, the coffee-based liquid that is fed through the cryogenic process may be freshly brewed coffee instead of espresso. FIG. 4 depicts a flowchart of an exemplary method of producing frozen beads using brewed coffee. The step are substantially the same as the steps described with respect to FIG. 3. In step 402, the coffee-based liquid is prepared such as by brewing coffee using known techniques and then additional flavors or additives can be incorporated in step 404. The resulting liquid can then be cooled in step 406, transported to a cryogenic processor, in step 408, where it is flash frozen into beads, in step 410. Once flash frozen, the beads can then be packaged, in step 412, and stored.

The brewed coffee liquid may have a consistency and viscosity that is not optimal for transporting and freezing. For example, the water content may be too high for efficient bead formation and freezing. Additionally, the ultimate beverage that results when the beads are reconstituted may require so many beads to have the desired coffee flavor that the product is unappealing. Thus, in step 406, the coffee-based liquid may be concentrated by extracting a portion of the water as it is cooled. The resulting liquid may therefore have a stronger coffee flavor and be easier to freeze into relatively uniform beads. However, using original strength brewed coffee is contemplated as well.

One of ordinary skill will recognize that different flavored beads may be frozen in separate freezing apparatuses at the same time or in the same freezing apparatus in a sequential manner. These different flavor beads can then be combined in different ratios at the packaging machine. In this way, different combinations of flavored coffee-based beverages may be created using the same set of beads in various permutations and combinations. Of course, a product consisting of one type of flavored bead is contemplated.

Once the beads are packaged and delivered to a consumer such as an individual, a coffee shop, a store, or a restaurant, the beads are stored in a conventional freezer until they are used to make a beverage. Although the beads are frozen at cryogenic temperatures, there is no requirement that they remain cooled to temperatures as low as −40° F. but, instead, may be maintained at the standard operating temperatures of commercial and consumer freezers.

The ultimate use for the frozen beads is to use them to produce a beverage for consumption. This can be accomplished in a variety of different ways without departing from the scope of the present invention. For example, the frozen beads may be brewed or steamed to reconstitute them much like coffee beans. The frozen beads may also be ground similar to regular coffee beans and used to make espresso and other similar beverages.

Accordingly, the packaging of the frozen beads can be accomplished in a variety of different ways depending on the desired product. For example, the beads may be packed in a cup sized container that is for a single serving, the cup can then be microwaved to make a hot coffee beverage that can be used as the base in a variety of drinks. Alternatively, the beads can be packaged in bulk packages from which a user can extract the desired amount of product to be reconstituted.

Utilizing the espresso beads described earlier, one or more shots of espresso can be made from the beads and then used in drinks such as americanos, macchiatos, con pannas, cappuccinos, caffe lattes, caffe mochas, and mochacchinos.

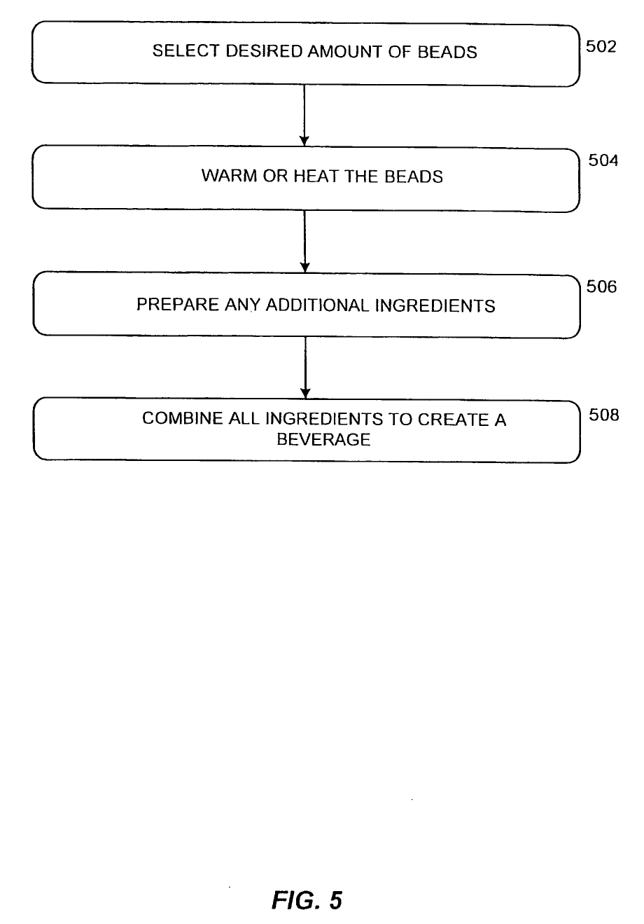

In general, a flowchart is shown in FIG. 5 of a method for making a coffee drink from the frozen beads described earlier. In step 502, the desired amount of beads are selected. These beads are flash-frozen coffee-based beads as described earlier such as, for example, the espresso beads or the brewed coffee beads. Depending on the desired beverage and the type of beads, the amount of beads will vary. For example, for a 12 to 16 oz. latte or cappuccino, anywhere from about 1 oz. to 3 oz. of espresso beads can be used. However, this ratio of ingredients can vary based on a desired beverage taste without departing from the scope of the present invention.

Next, in step 504, the beads are warmed or heated by any of a variety of methods. Warming them in a pan, microwaving them, heating them with hot steam, etc. are all methods that can be used to create a reconstituted coffee beverage base. Additionally, one of ordinary skill will recognize that any other well known method of warming the beads can be utilized without departing from the scope of the present invention. The resulting beverage base can be a stand-alone coffee-based beverage or potentially combined with other ingredients to form other coffee-based beverages.

The ingredients that will be combined with this coffee beverage base can vary widely. For example, milk, frothed milk, steamed milk, cream, and whipped cream are all likely candidates to add so as to make a variety of warm coffee-based beverages. Furthermore, the milk can vary from 1%, 2%, skim, lowfat, whole, and untraditional milk products such as soy, rice, goat, and the like. These additional ingredients can also includes syrups and flavors such as those traditionally paired with coffee such as chocolate, vanilla, hazelnut, Irish creme, caramel, peppermint, butter rum, mint, coffee liqueur, and others. Thus, in step 506, the additional ingredients are prepared in a manner appropriate for addition to the coffee beverage base and then everything is combined in step 508 to create a warm coffee beverage.

A few recipes for beverages resulting from embodiments of the present invention are presented not as a way to limit the invention but as evidence of its versatility. Furthermore, the proportions of the various ingredients are approximate suggestions and may readily be varied by a person to arrive at a desired beverage taste.

Cappuccino: 2 oz. espresso beads, 4.5 oz. steamed milk 4.5 oz. frothed milk. Caffe Latte: 2 oz. espresso beads, 10 oz. steamed milk, topped with frothed milk. Caffe Mocha: 2 oz. espresso beads, 10 oz. steamed milk, 2 oz: chocolates sauce, topped with whipped cream and drizzle chocolate sauce. Caramel Macchiato: 2 oz. espresso beads, 10 oz. steamed milk, ½ oz. vanilla syrup; topped with whipped cream and drizzle Caramel Syrup. Vanilla Latte: 2 oz. espresso beads, 10 oz. steamed milk, ½ oz. vanilla syrup, topped with frothed milk. White Mocha: 2 oz. espresso beads, 10 oz. steamed milk, 2 oz. white chocolate sauce, topped with whipped cream and drizzle white chocolate syrup.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A device comprising:
a coffee beverage maker configured to make a coffee-based beverage;
a cryogenic freezing apparatus;
a transport mechanism coupling an output of the coffee beverage maker with an input of the cryogenic freezing apparatus;
a tray coupled with the input of the cryogenic freezing apparatus, the tray configured to receive the coffee-based beverage and transform the coffee-based beverage into a plurality of droplets; and
wherein the cryogenic freezing apparatus is configured to freeze the plurality of droplets into individual beads.

2. The device of claim 1, wherein the coffee beverage maker further comprises an espresso maker.

3. The device of claim 1, wherein the coffee beverage maker further comprises an apparatus configured to brew coffee.

4. The device of claim 1, wherein the transport mechanism includes cooling devices.

5. The device of claim 1, wherein the transport mechanism includes a pump.

6. The device of claim 1, further comprising:
a cooling device coupled with the transport mechanism.

7. An edible product comprising:
cryogenically frozen coffee liquid formed in a beaded shape.

8. The edible product of claim 7, wherein the cryogenically frozen coffee liquid includes espresso.

9. The edible product of claim 7, wherein the cryogenically frozen coffee liquid includes brewed coffee.

10. The edible product of claim 7, wherein the beaded shape is approximately between 5 mm and 10 mm in diameter.

11. The edible product of claim 7, further comprising:
a plurality of beads of cryogenically frozen coffee liquid, wherein the plurality of beads remains pourable at a temperature of approximately 0° F.

12. A method of flash freezing coffee, comprising:
making a coffee-based beverage; and
cryogenically freezing the coffee-based beverage to form a plurality of beads of cryogenically frozen coffee liquid.

13. The method of claim 12, wherein making a coffee-based beverage includes making espresso.

14. The method of claim 12, wherein making a coffee-based beverage includes making brewed coffee.

15. The method of claim 12, further comprising:
concentrating the coffee-based beverage by reducing an amount of water present within the beverage.

16. The method of claim 12, further comprising:
adding additional flavoring to the coffee-based beverage.

17. A method of making a warm coffee beverage, comprising:
warming a plurality of beads of cryogenically frozen coffee liquid from a temperature of about 0° F. to a temperature considered comfortable for human consumption.

18. The method of claim 17, wherein the warm coffee beverage comprises espresso.

19. The method of claim 17, wherein the warm coffee beverage comprises brewed coffee.

20. The method of claim 17, further comprising:
adding one or more ingredients with the plurality warm coffee beverage to create a combination warm coffee drink.

21. The method of claim 20 wherein the one or more ingredients is selected from the group of: milk, cream, whipped cream, and frothed milk.
